(19) United States
(12) Patent Application Publication
(10) Pub. No.: US 2017/0124314 A1
(43) Pub. Date: May 4, 2017

(54) Device and Method for Keypad with an Integral Fingerprint Scanner

(71) Applicant: Tavita Laumea, Sparks, NV (US)

(72) Inventor: Tavita Laumea, Sparks, NV (US)

(21) Appl. No.: 15/342,944

(22) Filed: Nov. 3, 2016

Related U.S. Application Data
(60) Provisional application No. 62/249,998, filed on Nov. 3, 2015.

(51) Int. Cl. G06F 21/32; G06F 3/041; G06F 3/042; G06F 3/044; G06K 9/00

(52) U.S. Cl. CPC G06F 21/32; G06F 3/044; G06K 9/0002; G06F 3/042; G06K 9/00033; G06F 3/0416

(57) ABSTRACT

A keypad with an integral fingerprint scanner. The present system is a device and a method for inputting a passcode made up of a string of alphanumeric characters and one or more fingerprints. The device includes a housing having a front panel featuring a plurality of buttons having alphanumeric characters displayed thereon. A touch sensitive layer is mounted onto the front panel and can scan fingerprints that are placed above the buttons. A passcode is then input into the device having both a string of alphanumeric characters, as well as one or more fingerprints associated with it. Additionally, the present system includes a method implementing such a passcode.

### CROSS REFERENCE TO RELATED APPLICATIONS

This application claims the benefit of U.S. Provisional Application No. 62/249,998 filed on Nov. 3, 2015. The above identified patent application is herein incorporated by reference in its entirety to provide continuity of disclosure.

### BACKGROUND OF THE INVENTION

The present invention relates to input devices. More specifically, the present invention relates to input devices that are used to enter passcodes into various electronic devices.

Devices that require the input of passcodes are becoming ever increasingly common. From automatic teller machines to smartphones, the security of devices that are commonly used is increasing, due both to their popularity as well as attractiveness for security breaches. While alphanumeric passcodes have been used in many applications, secure passcodes require a lengthy string of characters, making them hard to remember. This is especially relevant with those who use passcodes for a multitude of devices. Many individuals wish to use different passcodes for each device, however remembering long passcodes can be difficult and frustrating.

Fingerprints are unique identifiers that are conveniently located close by at all times. Each individual possess a unique set of fingerprints that virtually no another person on the planet shares. As such, fingerprints have been taken advantage of in use as an identification method. However, most devices only use a single fingerprint to identify a user. Even devices that may store multiple fingerprints only require one of those in order to gain access to a device. This only increases the security of the device to a certain degree. A more complex passcode and fingerprint combination is desired.

### SUMMARY OF THE INVENTION

In view of the foregoing disadvantages inherent in the known types of input devices now present in the prior art, the present invention provides an input device wherein the same can be utilized for providing convenience for the user when inputting a passcode to access secure information. The present system comprises a device and a method for inputting a passcode made up of a string of alphanumeric characters and one or more fingerprints. The device comprises a housing having a front panel with button disposed thereon. A touch sensitive layer is placed on the front panel, and configured to scan fingerprints above the buttons. A passcode may then be input into the device comprising both a ring of alphanumeric characters as well as one or more fingerprints. Additionally, the present system includes a method implementing such a passcode.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the keypad with an integral fingerprint scanner.

FIG. 2 shows a perspective view of an embodiment of the keypad with an integral fingerprint scanner, showing a transparent touch sensitive layer.

FIG. 3 shows a perspective view of an alternative embodiment of the keypad with an integral fingerprint scanner.

FIG. 4 shows a flow chart of an exemplary method of using the keypad with an integral fingerprint scanner.

### DETAILED DESCRIPTION OF THE INVENTION

Reference is made herein to the attached drawings. Like reference numerals are used throughout the drawings to depict like or similar elements of the keypad with integral fingerprint scanner. The figures are intended for representative purposes only and should not be considered to be limiting in any respect.

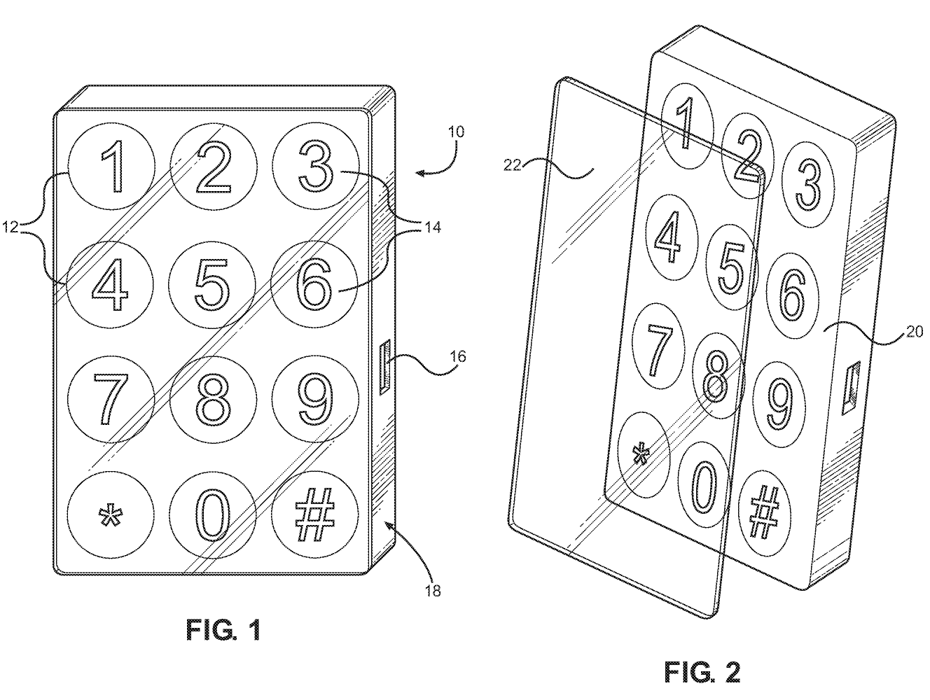

Referring now to FIGS. 1 and 2, there are shown perspective views of the keypad with integral fingerprint scanner. The keypad with integral fingerprint canner 10 comprises a housing having a front panel 20, a back panel and one or more sidewalls 18. A plurality of buttons 12 is disposed on the front panel 20 comprising a series of numbers 14 displayed thereon. A touch sensitive layer 22 is mounted directly on top of the front panel 20, wherein the touch sensitive layer 22 is configured to scan fingerprints that are placed directly above the buttons 12. A data port 16 is disposed along a sidewall, operably connected to both the touch sensitive layer and the plurality of buttons 12.

In some embodiments of the keypad with integral fingerprint scanner, the data port 16 is configured to connect to an external receiver to process the inputs. In the illustrated embodiment, the external receiver is an electronic device such as a computer or smart device. In other embodiments, there is a receiver integral to the keypad with integral fingerprint scanner disposed within the housing. In use, the keypad with integral fingerprint scanner 10 is configured to receive input from the user in the form of a numeric passcode, as well as the fingerprints of the user.

The touch sensitive layer incorporates a fingerprint scanner. In some embodiments of the keypad with integral fingerprint scanner 10, the touch sensitive layer 22 comprises a charge coupled device configured to record an optical image of a fingertip. The image captures the ridges and valleys present on an individual's fingertip. In other embodiments, the fingerprint scanner of the touch sensitive layer 22 comprises a capacitance scanner using electrical currents to detect the location of the ridges of a fingerprint that come into contact with the touch sensitive layer 22, and thus create a digital image of the fingerprint. These capture methods are implemented such that a fingerprint can be scanned at any place on the touch sensitive layer 22 that is directly above a button 12. For example, the touch sensitive layer may cover some or all of the buttons 12 dispose on the front panel 20. The fingerprints that are scanned can then be compared against a previously stored fingerprint image to determine if access should be granted.

In one embodiment of the keypad with integral fingerprint scanner 10, the previously recorded passcode is stored within a digital device operably connected to the keypad with integral fingerprint scanner 10. The passcode may comprise a single string of numbers along with one fingerprint. To properly gain access to the digital device, a user must input the correct string as well as touch the keypad with the finger previously used to record the fingerprint. Alternatively, multiple fingerprints may be stored such that in order to gain access to the digital device, the string of characters along with a specific order of multiple fingerprints must be used. In an additional embodiment of the keypad with integral fingerprint scanner, specific fingerprints must be used with specific buttons. For example, a passcode may require that an index finger fingerprint is used for the first input character, while a middle finger fingerprint is used for the second input character, thus increasing the security of the device. The amount of fingerprints required per passcode can be configured by the use when setting up the passcode.

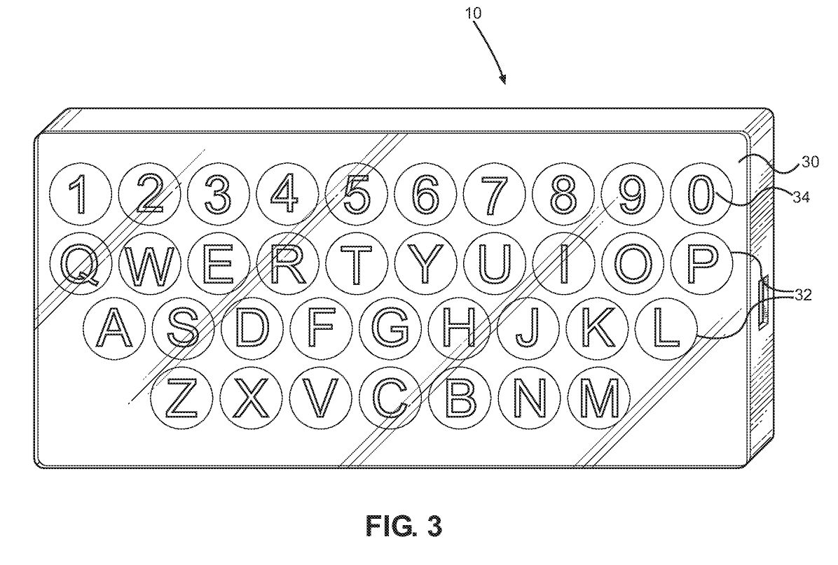

Referring now to FIG. 3, there is shown a perspective view of an alternative embodiment of the keypad with an integral fingerprint scanner. In some embodiments of the keypad with integral fingerprint scanner 10, the plurality of buttons 32 comprise a series of alpha numeric characters 34. This embodiment allows for more complex passcodes to be used with the invention. For example, the buttons 32 may include letters in addition to or in place of numbers for the input string of characters.

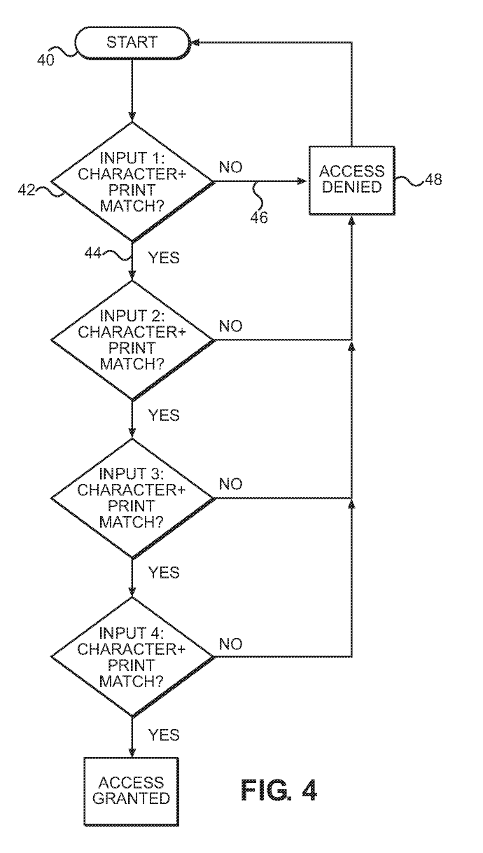

Referring now to FIG. 4, there is shown a flow chart of an exemplary method of using the keypad with an integral fingerprint scanner. A method of implementing the keypad with integral fingerprint scanner with multiple fingerprint matches starts 40 with a user inputting a first character 42 using a specific finger. If either the first character or fingerprint does not match a previously stored passcode 46, access is denied and the password must be reentered from the beginning. If both the first character and the first fingerprint match the stored passcode 44, the user can then move on to input the second character using either the same or a different fingerprint. If the second character and the fingerprint match, the user may move onto inputting the third character and fingerprint. Otherwise, access will be denied 48 and the user must start over again 40. Finally, the user must input the fourth character and fingerprint. If both correctly match the stored passcode, the user is granted access.

Alternative methods involve variations on how many characters are required to gain access to a device. An additional alternative method requires a different number of fingerprints. For example, one embodiment may only require a single fingerprint for the first character, while an alternative embodiment may require a first fingerprint for the first character and a second fingerprint for the last character of the passcode.

The keypad with integral fingerprint scanner device and the method used to implement it can be coupled with various devices. For example, something the keypad with integral fingerprint scanner may be used with an automatic teller machine to increase the security of a personal identification number used to gain access to a bank account. Additionally, the keypad with integral fingerprint scanner may be integrated within a personal digital device, such as a smartphone or a tablet, to increase the security to the passcode needed to gain access such a device.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A keypad with integral fingerprint scanner, comprising:
a housing including a front panel;
a plurality of buttons disposed on the front panel, wherein a character is displayed on each button; and
a touch sensitive layer comprising an integral fingerprint scanner disposed on the front panel.

2) The keypad with integral fingerprint scanner of claim 1, wherein the touch sensitive layer comprises a charge coupled device configured to capture an optical image of a fingerprint.

3) The keypad with integral fingerprint scanner of claim 1, wherein the touch sensitive layer comprises a capacitance scanner configured to capture a digital image of a fingerprint.

4) The keypad with integral fingerprint scanner of claim 1, wherein the buttons comprise a series of numbers.

5) The keypad with integral fingerprint scanner of claim 1, wherein the buttons comprise a series of alphanumeric characters.

6) The keypad with integral fingerprint scanner of claim 1, further comprising a data port operably connected to the touch sensitive layer, wherein the data port is configured to transmit fingerprint scans and button inputs to a receiver.

7) A method for inputting a passcode, comprising:
inputting a first character and a first fingerprint by contacting a touch sensitive layer comprising an integral fingerprint scanner;
comparing the first character and the first fingerprint against a previously stored passcode disposed in a receiver;
denying access to the receiver if either the first character or the first fingerprint fail to match the previously stored passcode;
allowing for input of a second character and a second fingerprint into the touch sensitive layer if both the first character and the first fingerprint match the previously stored passcode;
granting access to the receiver if a complete passcode matches the previously stored passcode.

8) A method for inputting a passcode, comprising:
inputting a first character and a first fingerprint by contacting a touch sensitive layer comprising an integral fingerprint scanner;
comparing the first character and the first fingerprint against a previously stored passcode disposed in a receiver;
denying access if either the first character or he first fingerprint fail to match the previously stored passcode, otherwise allowing for input of second character;
inputting a second character and a second fingerprint;
comparing the second character and the second fingerprint against the previously stored passcode;
denying access if either the second character or the second fingerprint fail to match the previously stored passcode, otherwise allowing for input of third character;
inputting a third character and a third fingerprint;
comparing the third character and the third fingerprint against the previously stored passcode;
denying access if either the third character or the third fingerprint fail the match the previously stored passcode, otherwise allowing for input of fourth character; and
comparing the fourth character and the fourth fingerprint against the previously stored passcode;
denying access if either the fourth character or the fourth fingerprint fail the match the previously stored passcode, otherwise granting access.
